(19) United States
(12) Patent Application Publication
(10) Pub. No.: US 2009/0152426 A1
(43) Pub. Date: Jun. 18, 2009

(54) Adjustable Mounting Assembly for Ceiling Fixtures

(76) Inventors: Michael John Longton, Baulkham Hills (AU); Paul Harriss, Quakers Hills (AU)

Correspondence Address: NIXON & VANDERHYE, PC, 901 NORTH GLEBE ROAD, 11TH FLOOR, ARLINGTON, VA, 22203, US

(21) Appl. No.: 12/336,784

(22) Filed: Dec. 17, 2008

(30) Foreign Application Priority Data
Dec. 18, 2007 (AU) 2007101204

(51) Int. Cl. F16M 13/00

(52) U.S. Cl. 248/343

(57) ABSTRACT

An adjustable mounting assembly for ceiling fixtures has a pair of opposingly spaced apart mounting brackets (12,14) for mounting onto respective ones of a pair of spaced apart ceiling joists (20,22). The mounting brackets (12,14) include apertures (28,30) which receive therebetween a telescopic tube (16) comprising a first tubular member (32) and a second tubular member (34) being slidably received within the first tubular member (32). The first and second tubular members (32,34) are movable in opposing axial directions between a retracted position and an extended position to suit a distance between the ceiling joists (20,22). The telescopic tube (16) has mounted thereon a carrier bracket (18) which is adapted to move axially along the telescopic tube (16). The carrier bracket (18) includes a downwardly facing aperture (50) and axial movement of the carrier bracket (18) along the telescopic tube (16) allows the downwardly facing aperture (50) to align with the desired position of the fixture on the ceiling.

### FIELD OF THE INVENTION

The present invention relates to an adjustable mounting assembly for ceiling fixtures, such as ceiling fans, chandeliers, light fittings and electrical junction boxes for the aforementioned devices. In particular, the present invention relates to a mounting assembly that is adjustable in length and orientation and so can be secured between ceiling joists that are spaced at different distances apart, and at different angles to each other. More particularly, the present invention relates to an adjustable mounting assembly having a movable carrier bracket which can be readily aligned with a desired position of a ceiling fixture.

### BACKGROUND OF THE INVENTION

Ceilings are typically constructed of structural members including a plurality of spaced apart joists which support a ceiling covering material, such as plaster or a gypsum board often referred to as “gyprock”.

In this specification and claims, the term “joist” includes within its meaning a joist-like portion of a roof truss which supports a ceiling covering material.

The ceiling covering material is not designed to support loads perpendicular to its surface. Therefore, in order to suspend a fixture from a ceiling, the fixture's weight must be supported by the joists. To achieve this, a fixture should be secured directly to a joist, however, this limits the range of locations where the fixture may be placed.

Such a limitation is problematic since it is often desirable to place the fixture in a specific position on the ceiling. Therefore, if no joist is positioned at or near the desired position, direct joist connection is not possible.

A preferred solution for supporting fixtures from a ceiling has been the use of a mounting assembly.

Known mounting assemblies for ceiling fixtures are awkward to install. Generally, installing known mounting assemblies requires the installer to measure and mark installation points on the joists. A wooden brace for interconnecting a pair of joists must be cut to size and then visually aligned with the installation points on the joists. Securing the brace to the joists becomes difficult if the brace was cut to the incorrect size, or was not in the correct position when marking the installation points. A need exists for a mounting assembly that does not require the cutting of a wooden brace to size, but is adjustable in length and orientation and so can be secured between ceiling joists that are spaced at different distances apart and at different angles to each other, and has a movable carrier bracket which can be readily aligned with a desired position of a ceiling fixture.

### SUMMARY OF THE INVENTION

It is, therefore, an object of the present invention to provide a simple and effective mounting assembly for ceiling fixtures capable of accommodating a wide variety of joist structures in a ceiling and including an adjustable carrier bracket.

It is another object of the present invention to provide an inexpensive mounting assembly for ceiling fans and other fixtures that is easily and efficiently installed.

According to the present invention, there is provided an adjustable mounting assembly for a ceiling fixture, said assembly comprising a pair of opposingly spaced apart mounting brackets for mounting onto ceiling joists, the mounting brackets including means for receiving therebetween a length adjustable tube to suit a desired distance between a pair of spaced apart ceiling joists, the tube having mounted thereon a carrier bracket including a downwardly facing aperture, the carrier bracket being so adapted as to allow the downwardly facing aperture to align with a desired position of the fixture on the ceiling.

Preferably, the carrier bracket is adapted to move axially along the tube, whereby axial movement of the carrier bracket along the tube allows the downwardly facing aperture to align with a desired position of the fixture on the ceiling.

It is also preferred that the length adjustable tube is a telescopic tube comprising a first tubular member and a second tubular member being slidably received within the first tubular member, the first and second tubular members being movable in opposing axial directions between a retracted position and an extended position to suit a desired distance between a pair of spaced apart ceiling joists.

In an alternative form, the length adjustable tube is a prefabricated single piece tube that is adjustable in length by cutting from one or both ends thereof a portion or portions of the tube to suit a desired distance between a pair of spaced apart ceiling joists.

In that alternative form, the carrier bracket may be rigidly mounted to the tube, say, by welding, by a tight interference fit, or by integral moulding, and the cutting of the tube allows the downwardly facing aperture of the carrier bracket to align with a desired position of the fixture in the ceiling.

In a preferred form, the means for receiving therebetween the tube comprise one or more apertures.

In an alternative form, the means for receiving therebetween the tube comprise one or more projecting members.

Preferably, there are first and second tube receiving apertures in each of the mounting brackets, the first tube receiving aperture being circular so as to receive the tube perpendicularly when the pair of spaced apart ceiling joists are parallel, and the second tube receiving aperture being oval shaped so as to receive the tube obliquely when the pair of spaced apart ceiling joists are not parallel.

More preferably, the carrier bracket includes an earthing point for electrical fault protection.

In a preferred form, the downwardly facing aperture in the carrier bracket includes a grommet engaged about the rim of the aperture.

It is preferred that the mounting brackets are mounted to the joists with one or more screws.

In yet another preferred form, the carrier bracket includes opposed end plates having respective first and second sideways facing apertures for receiving the tube therethrough.

### SUMMARY OF THE DRAWINGS

In order that the invention may be more readily understood and put into practical effect, reference will now be made to the accompanying drawings, in which:—

FIG. 1 is a perspective view of an adjustable mounting assembly for a ceiling fixture mounted between parallel joists according to a preferred embodiment of the invention,

FIG. 2 is a side view of a mounting bracket used in the assembly of FIG. 1,

FIG. 3 is a top view of the mounting bracket of FIG. 2,

FIG. 4 is a side view of the first tubular member of a telescopic tube used in the assembly of FIG. 1,

FIG. 5 is a side view of the second tubular member of a telescopic tube used in the assembly of FIG. 1,

FIG. 6 is a side view of a carrier bracket used in the assembly of FIG. 1,

FIG. 7 is an end view of the carrier bracket of FIG. 6, and

FIG. 8 is a perspective view of an adjustable mounting assembly for a ceiling fixture mounted between parallel joists according to another preferred embodiment of the invention.

### DETAILED DESCRIPTION OF THE PREFERRED EMBODIMENTS

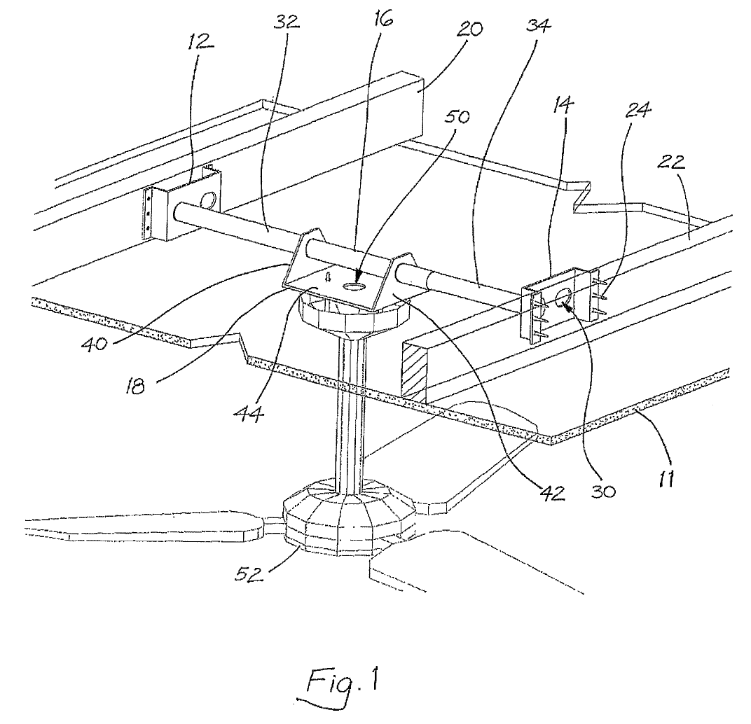

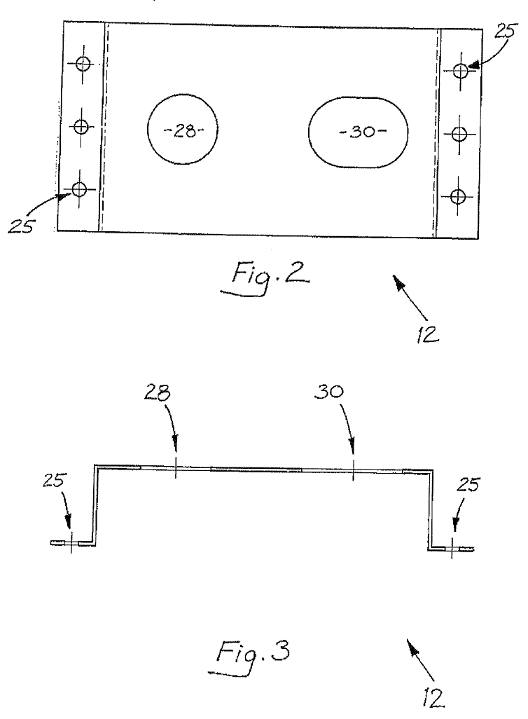

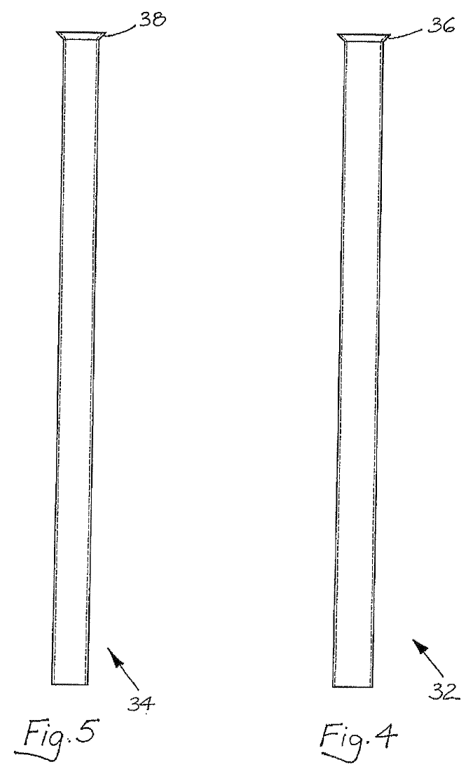

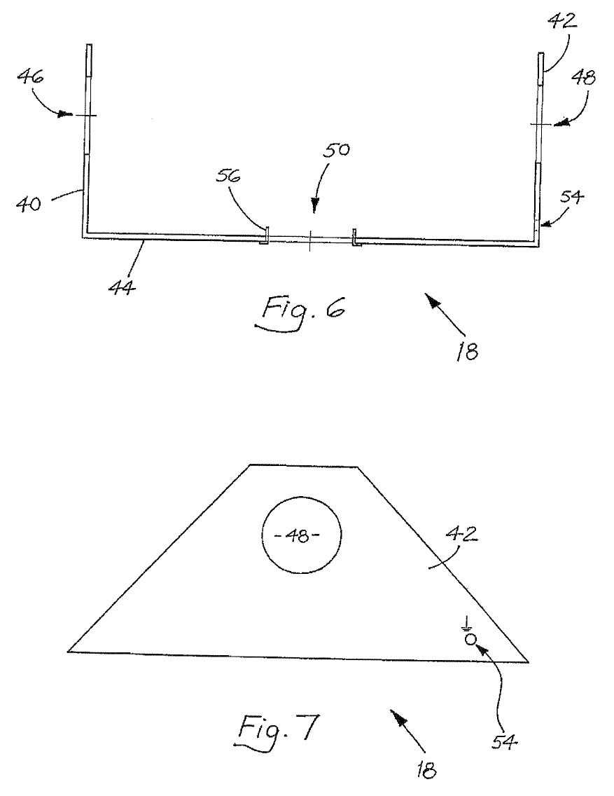

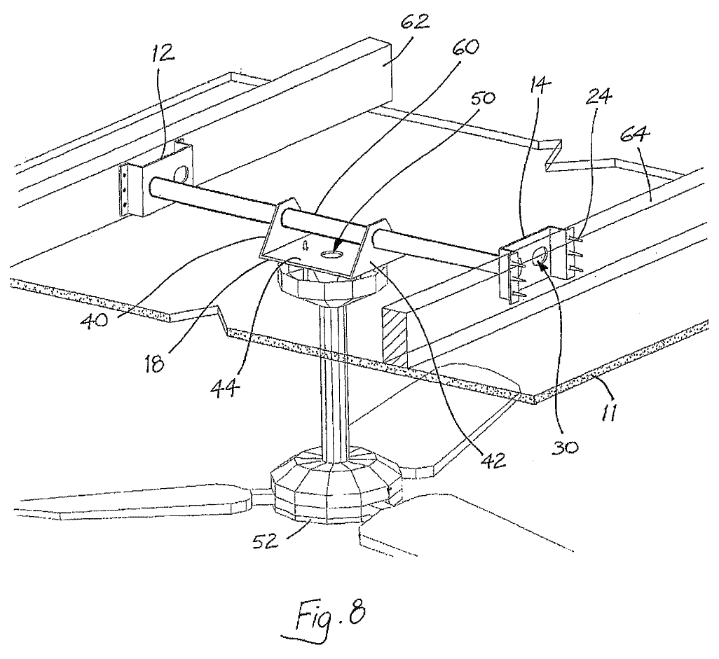

The adjustable mounting assembly shown installed on a ceiling 11 in FIG. 1 has a pair of opposingly spaced apart mounting brackets 12, 14 (one bracket of the pair being shown in FIGS. 2 and 3), a telescopic tube 16 (first and second tubular members of the tube 16 being shown in FIGS. 4 and 5), and a carrier bracket 18 (as shown in FIGS. 6 and 7).

The mounting brackets 12, 14 are mounted onto a pair of spaced apart ceiling joists 20, 22, respectively, by a plurality of screws 24 engaged through screw holes 25. The mounting brackets 12, 14 include means, in the form of apertures 28, 30, for receiving therebetween the telescopic tube 16. The apertures 28 are circular so as to receive the telescopic tube 16 perpendicularly when the ceiling joists are parallel as shown in FIG. 1. The apertures 30 are oval shaped so as to receive the telescopic tube 16 obliquely when the ceiling joists are not parallel, such as when they are perpendicular.

Alternatively, the mounting brackets 12, 14 may include projecting members or protuberances (not shown) for receiving therebetween the telescopic tube 16, such as where the opposite hollow ends of the tube 16 capture therewithin respective projecting members.

The telescopic tube 16 has a first tubular member 32 and a second tubular member 34 which, by virtue of its slightly smaller diameter, is slidably received within the first tubular member 32. Each tubular member 32, 34 has a flared end 36, 38, respectively, which is captured by an aperture in one of the mounting brackets 12, 14.

The first and second tubular members 32, 34 are movable in opposing axial directions between a retracted position and an extended position to suit the distance between the ceiling joists 20, 22.

Mounted on the first tubular member 32 of the telescopic tube 16 is the carrier bracket 18. The carrier bracket 18 has opposed end plates 40, 42 interconnected by a base plate 44. The end plates 40, 42 include first and second sideways facing apertures 46, 48, respectively, for receiving the first tubular member 32 therethrough. In the particularly preferred form shown, the carrier bracket 18 is slidably mounted to the first tubular member 32, say, by the diameter of the apertures 46, 48 being slightly greater than the diameter of the tubular member 32. In an alternative form, the carrier bracket 18 may be rigidly mounted to the first tubular member 32, say, by a tight interference fit of the tubular member 32 with the apertures 46, 48.

The carrier bracket 18 is able to move axially along the first tubular member 32 of the telescopic tube 16 so as to adjust its position between the ceiling joists 20, 22.

The base plate 44 of the carrier bracket 18 includes a downwardly facing aperture 50 having a diameter suitable for receiving therethrough the electrical cabling and other items of a ceiling fixture to be mounted to the assembly. As shown in FIG. 1, the fixture is a ceiling fan 52, but may alternatively be an electrical junction box.

By adjusting the position of the carrier bracket 18 between the ceiling joists, the aperture 50 is able to align with the desired position of the ceiling fan 52.

As a result, the ceiling fan 52 can be located at a desired position on the ceiling 11 remote of a joist and have its weight supported stably between the nearest pair of spaced apart joists.

The carrier bracket 18 has an earthing point in the form of a hole 54 to which an earthing cable, for example, can be engaged to allow the carrier bracket 18 to be connected to the earthing system of the electrical circuit for the fan, thereby preventing the assembly from becoming electrified in the event of a fault.

A grommet 56 (as shown in FIG. 6) is engaged about the rim of the downwardly facing aperture 50 to prevent contact between the carrier bracket 18 and the electrical cabling and other items of the ceiling fixture.

The adjustable mounting assembly shown installed on a ceiling in FIG. 8 is similar in many respects to the assembly installed on ceiling 11 shown in FIG. 1, but differs therefrom by substitution of the telescopic tube 16 with a prefabricated single piece tube 60 that is adjustable in length by cutting from one or both ends thereof a portion or portions of the tube to suit the distance between a pair of spaced apart ceiling joists 62,64. Those features of the assemblies shown in FIGS. 1 and 8 which are identical have been numbered identically, and regard should be had to the description of those features with reference to the assembly shown in FIGS. 1 to 7 as to their structure and function in the context of the assembly shown in FIG. 8.

The tube 60 of the assembly shown installed on a ceiling in FIG. 8 has had one end portion thereof cut off to enable it to assume a length that suits the distance between the parallel joists 62,64. Some slight variation in the so cut length can be tolerated because of the use of the mounting brackets 12,14, each of which provides an accommodating space between the apertures 28,30 and the joists 62,64 to which the mounting bracket is mounted.

The carrier bracket 18 is able to move axially along the tube 60 so as to adjust its position between the ceiling joists 62,64.

Alternatively, the carrier bracket may be rigidly mounted to the tube 60, say, by welding, by a tight interference fit, or by integral moulding, and it is the cutting of the tube 60 to length that allows the downwardly facing aperture 50 of the carrier bracket to align with a desired position of the fixture on the ceiling.

It will be apparent to persons skilled in the art that various modifications may be made in details of design and construction of the adjustable mounting assembly described above without departing from the scope or ambit of the present invention.

1. An adjustable mounting assembly for a ceiling fixture, said assembly comprising a pair of opposingly spaced apart mounting brackets for mounting onto ceiling joists, the mounting brackets including means for receiving therebetween a length adjustable tube to suit a desired distance between a pair of spaced apart ceiling joists, the tube having mounted thereon a carrier bracket including a downwardly facing aperture, the carrier bracket being so adapted as to allow the downwardly facing aperture to align with a desired position of the fixture on the ceiling.

2. The adjustable mounting assembly of claim 1 wherein the carrier bracket is adapted to move axially along the tube, whereby axial movement of the carrier bracket along the tube allows the downwardly facing aperture to align with a desired position of the fixture on the ceiling.

3. The adjustable mounting assembly of claim 1 wherein the length adjustable tube is a telescopic tube comprising a first tubular member and a second tubular member being slidably received within the first tubular member, the first and second tubular members being movable in opposing axial directions between a retracted position and an extended position to suit a desired distance between a pair of spaced apart ceiling joists.

4. The adjustable mounting assembly of claim 1 wherein the length adjustable tube is a prefabricated single piece tube that is adjustable in length by cutting from one or both ends thereof a portion or portions of the tube to suit a desired distance between a pair of spaced apart ceiling joists.

5. The adjustable mounting assembly of claim 4 wherein the carrier bracket is rigidly mounted to the tube, and the cutting of the tube allows the downwardly facing aperture of the carrier bracket to align with a desired position of the fixture in the ceiling.

6. The adjustable mounting assembly of claim 1 wherein the means for receiving therebetween the tube comprise one or more apertures.

7. The adjustable mounting assembly of claim 1 wherein the means for receiving therebetween the tube comprise one or more projecting members.

8. The adjustable mounting assembly of claim 6 wherein there are first and second tube receiving apertures in each of the mounting brackets, the first tube receiving aperture being circular so as to receive the tube perpendicularly when the pair of spaced apart ceiling joists are parallel, and the second tube receiving aperture being oval shaped so as to receive the tube obliquely when the pair of spaced apart ceiling joists are not parallel.

9. The adjustable mounting assembly of claim 1 wherein the carrier bracket includes an earthing point for electrical fault protection.

10. The adjustable mounting assembly of claim 1 wherein the downwardly facing aperture in the carrier bracket includes a grommet engaged about the rim of the aperture.

11. The adjustable mounting assembly of claim 1 wherein the mounting brackets are mounted to the joists with one or more screws.

12. The adjustable mounting assembly of claim 1 wherein the carrier bracket includes opposed end plates having respective first and second sideways facing apertures for receiving the tube therethrough.
